(19) United States
(12) Patent Application Publication
(10) Pub. No.: US 2023/0411902 A1
(43) Pub. Date: Dec. 21, 2023

(54) CABLE SUPPORT

(71) Applicant: SAFRAN ELECTRICAL COMPONENTS, Slough Berkshire (GB)

(72) Inventors: Ajit Borade, Slough Berkshire (GB); Mo Shiran, Slough Berkshire (GB)

(21) Appl. No.: 18/253,325

(22) PCT Filed: Nov. 15, 2021
(86) PCT No.: PCT/GB2021/052939

§ 371 Date: May 17, 2023

(30) Foreign Application Priority Data
Nov. 18, 2020 (GB) 2018100.4

(51) Int. Cl. H01R 13/58; H01R 13/56

(52) U.S. Cl. CPC H01R 13/5812; H01R 13/562; H01R 13/5841; H01R 2201/26

(57) ABSTRACT

A backshell is configured to be connected to an electrical connector. The backshell includes a backshell body configured to receive a cable connectable with the electrical connector. The backshell also includes a fixed tail portion extending from the backshell body. The fixed tail portion provides a plurality of different connection positions spaced along a curved exit path extending from the backshell body. A fastening component can be connected to the fixed tail portion to retain the cable to the fixed tail portion at one of the plurality of different connection positions. The connection positions include fastening component engagement means, configured to retain the fastening component in position longitudinally with respect to the curved exit path. Connection of the fastening component at the different respective connection positions guides the cable from the fixed tail portion at different respective exit angles.

### TECHNICAL FIELD

The invention relates to a cable support for an electrical connector. In particular, the invention relates to a variable angle cable support for use in particular in an aircraft environment.

### BACKGROUND OF THE INVENTION

Cables used for the transfer of power and data can sometimes require mechanical support. Cables in an aircraft may be provided in a cable harness, which includes cable bundles that are split to provide communication of power and/or data around the aircraft. Cable harnesses generally terminate in an array of multi-point connectors. The connection between such connectors and the cables can be protected from cable pull-out by backshells. A backshell can be fastened to these components to direct the orientation of the cable bundle, while providing strain relief, and may further shield from electromagnetic interference (EMI). The orientation of a backshell is usually provided by a moulded-in or machined profile, which can support a cable bundle in a number of directions, such as 0 degrees from an axis of the connector body, or 45 degrees or 90 degrees from such an axis. This is normally achieved by selecting a backshell having a different profile during assembly, which necessitates the provision of a new product for each orientation required. Some prior backshells include a rotatable arm to solve this problem, but these tend to comprise many components and can be complex to manufacture and install.

There exists a need for improvements in cable supports such as backshells.

### SUMMARY OF THE INVENTION

The inventors have identified several problems with known backshells. Firstly, some known backshells are capable of supporting a cable arrangement in only a single orientation with respect to the connector. Otherwise stated, such prior backshells can only support a cable at a single exit angle. As a result of this limitation, depending on the geometry of a particular installation site, different types of these known backshells may be required in order to support cables in a variety of orientations. A different type of known backshell includes a rotating arm in order to support a cable at a range of selectable orientations. However, this type of backshell can comprise many moving parts and may not be sufficient to fully support a cable arrangement at high curvatures.

The inventors have devised a new backshell to address these problems in the known art. The backshell includes a backshell body which can receive a cable bundle or cable harness for connection with an electrical connector. Extending from the backshell body is a fixed tail portion which can guide the cable bundle along a curved exit path. To do this, the tail portion includes a plurality of connection positions disposed at different positions along the exit path. The cable bundle can be retained by the backshell by connecting a fastening component to the fixed tail portion at one of the multiple connection positions. Depending on the connection position to which the fastening component is fixed, the cable can be guided from the fixed tail portion at a variety of orientations or exit angles.
According to one aspect of the present invention, there is provided a backshell configured to be connected to an electrical connector, the backshell comprising:
   a backshell body configured to receive a cable connectable with the electrical connector, and
   a fixed tail portion extending from the backshell body, the fixed tail portion configured to provide a plurality of different connection positions spaced along a curved exit path extending from the backshell body, at which a fastening component can be connected to the fixed tail portion to retain the cable to the fixed tail portion;
   the plurality of connection positions comprising fastening component engagement means, configured to retain the fastening component in position longitudinally with respect to the curved exit path;
   wherein connection of the fastening component to the fixed tail portion at the different respective connection positions guides the cable from the fixed tail portion at different respective exit angles.

A backshell according to the present invention can support a bend in the cable harness, wherein the angle of the bend can be one of a plurality of angles. This is achieved by means of a relatively simple construction with few components. Furthermore, the desired exit angle of a cable can be determined at the point of fixing the fastening component to the fixed tail portion. This is in contrast to prior arrangements, in which a tail portion must be moved relative to the backshell body in order to select a different exit angle.

The fixed tail portion may be an integral part of the backshell body. This has the advantage of providing a backshell which is simpler to manufacture without requiring numerous assembly steps.

The curved exit path may be defined along a surface of the fixed tail portion. The fixed tail portion may comprise a cable support surface. The cable support surface may be configured to direct the cable along the curved exit path. A proximal end of the cable support surface may be parallel to a longitudinal axis of the backshell. A distal end of the cable support surface may be non-parallel to the longitudinal axis of the backshell. The cable support surface may have a curved profile. The cable support surface may comprise a smooth tubular surface. The cable support surface may be defined by a geometric saddle point. This provides an advantageous backshell in which the clamping forces that may be exerted on a cable secured by the backshell are distributed along the cable support surface. Furthermore, this provides a backshell having a smooth surface over which a bend in the cable or cable harness can be supported.

The fixed tail portion and the fastening component may be configured to clamp the cable therebetween. At least one of the plurality of connection positions may comprise an opening. The opening may be configured to engage the fastening component. The plurality of connection positions may comprise a proximal connection position. The plurality of connection positions may comprise a distal connection position. The plurality of connection positions may comprise an intermediate connection position. The intermediate connection position may be located at a position along the curved exit path between the proximal connection position and the distal connection position.

At least one aperture may be provided at an underside of the cable support surface. The at least one aperture may be located in the region of at least one of the plurality of connection positions, to receive the fastening component so as to retain the cable at the at least one connection position.

According to an aspect of the present invention, there is provided a method of assembling an electrical connector to a cable, the method comprising:
providing an electrical connector;
providing a backshell as described hereinabove to the electrical connector;
connecting at least one cable to the electrical connector; and securing the at least one cable to the backshell by selecting at least one of the plurality of connection positions and connecting the fastening component to the fixed tail portion at the selected connection position(s).

The method may further comprise the step of leaving at least one of the plurality of connection positions unoccupied by any fastening component. In this way, only one or more of a subset of the available connection positions needs to be occupied by a fastening component to secure a cable. This has the advantage of providing a method that enables securing a cable or cable harness at a variety of exit angles from a connector in a faster and more efficient manner with a reduced number of parts and assembly operations.

### BRIEF DESCRIPTION OF THE DRAWINGS

Further features and advantages of the present invention will become apparent from the following description of embodiments thereof, presented by way of example only, and by reference to the drawings, in which:

FIG. 1 is a schematic diagram illustrating a side view of a backshell according to an embodiment;

FIG. 2 is a schematic diagram illustrating a perspective view of a tail portion of the backshell according to an embodiment;

FIG. 3 is a schematic diagram illustrating a further perspective view of the tail portion according to an embodiment along with a fastening component;

FIG. 4 is a schematic diagram illustrating a perspective view of the tail portion according to an embodiment with a fastening component at a connection position;

FIG. 5 is a schematic diagram illustrating a perspective view of the tail portion according to an embodiment with a fastening component at a further connection position;

FIG. 6 is a schematic diagram illustrating a perspective view of the tail portion according to an embodiment with a fastening component at yet another connection position.

### DETAILED DESCRIPTION

A backshell is described herein in the context of an electrical connector such as the type employed for the transfer of power and data throughout an aircraft. The backshell can act as a support to improve a mechanical connection between an electrical connector and a cable, or cable bundle, configured to be connected with the electrical connector. The backshell comprises a backshell body which can be sized and shaped so as to receive a cable. It will be appreciated that backshells are typically employed to secure a cable harness, which can be made up of one or more cable bundles, each of which can comprise a plurality of cables. In order to secure a cable to a backshell (or cable harness or cable bundle), a fixed tail portion is provided as an extension from the backshell. A curved exit path extends from the backshell body which can define a path along which a cable can be secured. The cable can be secured at one of a plurality of different connection positions spaced along the curved exit path. In order to retain the cable to the fixed tail portion at one of the plurality of different connection positions, a fastening component can be connected to the fixed tail portion in order to guide the cable from the fixed tail portion at different respective exit angles. That is to say, depending on the position at which the fastening component is fixed to the tail portion, the cable can be retained at different positions along the curved exit path so as to provide a desired exit angle of the cable from the fixed tail portion.

The cable can be fixed to the fixed tail portion by a plurality of different fastening means, such as, in one example, a cable tie. In this respect, the tail portion may comprise one or more apertures or channels at one or more of the connection positions in which a flexible strap such as a cable-tie may be received or through which a cable tie may be threaded, so as to surround the curved exit path and retain the cable against the fixed tail portion. Such apertures or channels can provide an engagement region for a fastening component to be secured to the fixed tail portion. The engagement region may be provided at the plurality of different connection positions, to enable the cable or cables to be secured to the fixed tail portion at the different connection positions. The engagement region can act as a fastening component engagement means, configured to restrict movement of the fastening component longitudinally, or tangentially, with respect to the curved exit path, i.e. to prevent movement of the fastening component along a length or path of the cable(s) and/or the fixed tail portion. The fastening component may comprise a substantially rigid, substantially arc-shaped component, which may be fixed to the tail portion by any suitable mating interface, such as a screw in a corresponding threaded bore, a slot in a corresponding recess, and/or a projection in a corresponding recess or aperture in the fixed tail portion.

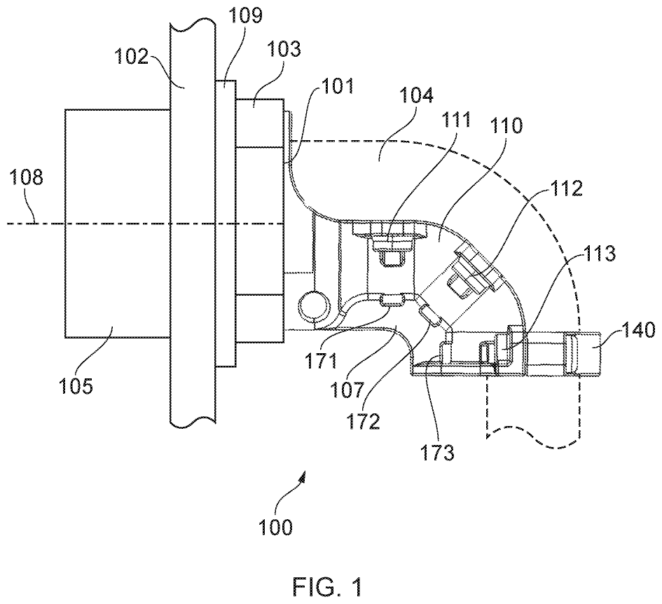

Referring to the drawings, FIG. 1 shows a backshell 100 in relation to which embodiments of the invention will be described. The backshell 100 comprises a backshell body 101 which may be disposed around a body axis 108. The backshell 100 is configured to be connected to an electrical connector 105 and may be connectable thereto in a direction of the body axis 108. A cable 104, which may refer to a single cable, cable bundle, or cable harness, can be received by the backshell body 101 so as to be connectable to the electrical connector 105 along the body axis 108 of the backshell body 101. The electrical connector 105 and the backshell body 101 may be configured to be disposed on opposite sides of a panel 102. The backshell body 101 may be connected to the panel 102 by means of a connection plate 109. The backshell body 101 may be fixed to the connection plate 109 by means of a threaded engagement provided by a nut 103 disposed around the backshell body 101 and a threaded outer surface of an extension of the plate 109. The backshell body 101 may comprise a substantially annular portion configured such that upon engagement with the panel 102 or the electrical connector 105, the body axis 108 of the backshell body 101 is aligned with the direction of connection of the cable 104 with the electrical connector 105.

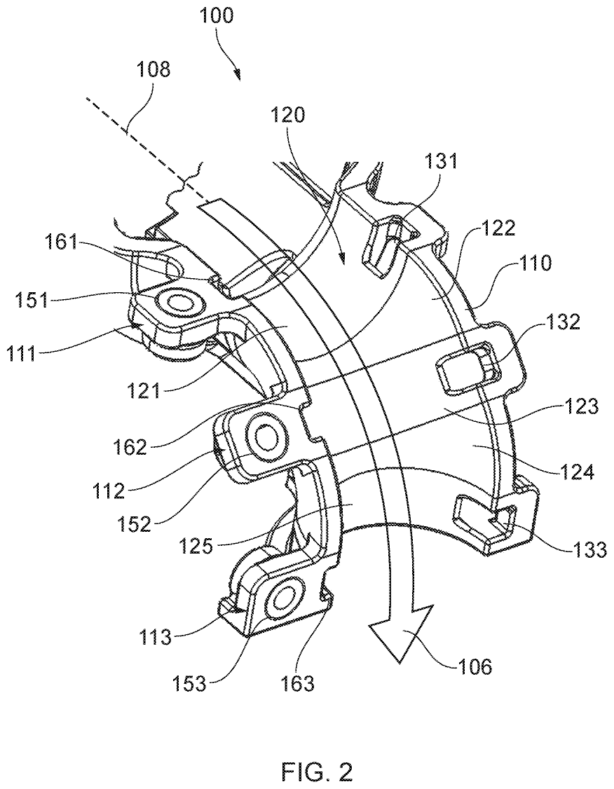

The backshell 100 further comprises a fixed tail portion 110. The fixed tail portion 110 extends from the backshell body 101. In the example shown, the fixed tail portion 110 extends from a side of the backshell body 101 opposite to that at which the backshell body 101 is connectable with the electrical connector 105. A proximal end of the fixed tail portion 110 may be fixed to the backshell body 101. Alternatively, the fixed tail portion 110 may be an integral part of the backshell body 101. At a proximal end, the fixed tail portion 110 may extend from the backshell body 101 in the direction of the body axis 108. Towards a distal end, the fixed tail portion 110 may gradually deviate from the body axis 108. With reference to the example of the backshell 100 shown in FIGS. 1 and 2, the fixed tail portion 110 may comprise a cable support surface 120. A curved exit path 106 can be envisaged, beginning at the backshell body 101, and extending along a contour of the fixed tail portion 110 beyond the exit of the backshell 100. The curved exit path 106 may be defined along a contour of the fixed tail portion 110.

At the underside of the cable support surface 120, the fixed tail portion 110 may comprise a structural member 107. The underside may also be referred to as a side of the curved tail portion closer to the centre of curvature of the curved exit path, or as an opposite side of the fixed tail portion to the surface to which the cable(s) are to be mounted. The structural member 107 may be a substantially flat component extending perpendicularly from a bottom surface of the fixed tail portion 110. The structural member 107 may lie in a plane in which the curved exit path 106 is defined. The structural member 107 may comprise at least one aperture. In the illustrated example, the structural member 107 comprises a first aperture 171, a second aperture 172 and a third aperture 173. The positions of the apertures 171, 172, 173 may correspond to a plurality of connection positions spaced along the curved exit path 106 of the fixed tail portion 110. In the illustrated arrangement, the fixed tail portion 110 provides a first connection position 111, a second connection position 112, and a third connection position 113. In this respect, the first aperture 171 in the structural member 107 may be located at a position along the curved exit path 106 at the first connection position 111. The same may be true of the positioning of the second aperture 172 with respect to the second connection position 112, and of the third aperture 173 with respect to the positioning of the third connection position 113. The apertures may be replaced by u-profile recesses, grooves or channels, which may be open in the radially inner direction of the curved exit path, and which limit movement of the fastening component in a longitudinal direction along the curved exit path. In the example shown, a fastening component 140 is shown to be fixed to the fixed tail portion 110 at the third connection position 113.

FIG. 2 illustrates further detail of the fixed tail portion 110 of the backshell 100. In the embodiment shown, the cable support surface 120 comprises a half pipe that curves away from the body axis 108 such that an open side of the half pipe faces away from the electrical connector 105. The cable support surface 120 may be considered as having a shape resembling a geometric saddle point. Otherwise stated, the cable support surface 120 can comprise a curved half pipe whose concave face is directed away from the backshell body 101. In some embodiments, the cable support surface 120 may comprise a substantially curved surface. In the embodiment shown, the cable support surface 120 comprises a plurality of surface portions that are orientated with respect to one another and with respect to the curved exit path so as to provide support to a cable following the curved exit profile along the path of the curved exit path. The cable support surface 120 may, for example, comprise a first surface portion 121, second surface portion 122, third surface portion 123, fourth surface portion 124 and a fifth surface portion 125. The first 121, third 123 and fifth 125 surface portions may comprise part-cylindrical or part-annular portions of the cable support surface 120, and may be considered to be provided as a half pipe, or other part-pipe section, such as quarter-pipe or other portion of a pipe profile. The first surface portion 121 may have a longitudinal axis, that is, an axis of a notional annulus of which the first surface portion 121 can be defined, disposed at a first angle to the body axis 108, wherein the first angle may be 0 degrees. The first surface portion 121 may be parallel to, or co-linear with, the body axis 108. The third surface portion 123 may be comprised in the cable support surface 120 such that a longitudinal axis of the third surface portion 123 intersects the body axis 108 at a second angle different from the first, for example an angle of 45 degrees. The fifth surface portion 125 may be comprised in the cable support surface 120 such that a longitudinal axis of the fifth surface portion 125 intersects the body axis 108 at a third angle, different from the first and second, for example an angle of 90 degrees. In other words, the fifth surface portion 125 may be perpendicular to the body axis 108. It will be appreciated in light of the present disclosure that the first second and third angles may be selected to have different values according to alternative implementations falling within the scope of this disclosure.

The second surface portion 122 and the fourth surface portion 124 may be provided as bridging surfaces of the cable support surface 120 to connect the first 121, third 123, and fifth 125 surface portions. In the embodiment shown, the second surface portion 122 bridges the first surface portion 121 with the third surface portion 123, and the fourth surface portion 124 bridges the third surface portion 123 with the fifth surface portion 125. At least one of the second surface portion 122 and the fourth surface portion 124 may comprise a curved half pipe portion, which may be considered as a geometric saddle point. By way of the surface portions 121, 122, 123, 124, 125 the cable support surface 120 can comprise a smooth tubular surface along which the cable 104 can be supported. The second and fourth surface portions could also be omitted and the first, third and fifth surface portions supported with respect to one another by other means, such as the structural member 107, for example.

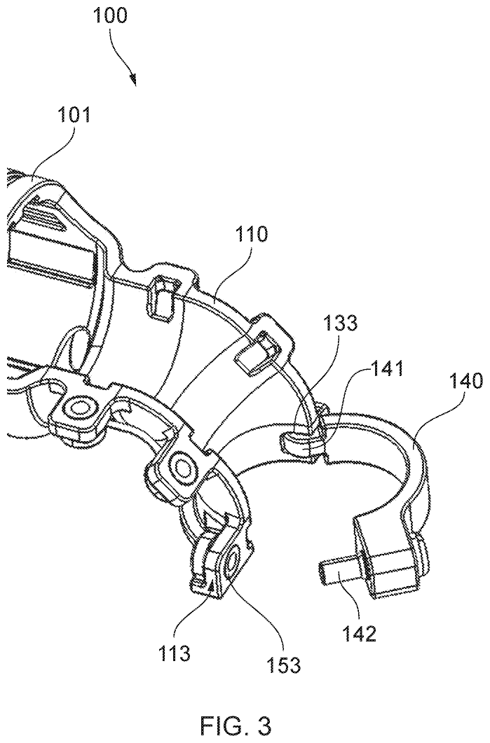

As discussed above in relation to FIG. 1, the fixed tail portion 110 provides a plurality of different connection positions spaced along the curved exit path 106 extending from the backshell body 101. The plurality of connection positions comprises fastening component engagement means, configured to retain the fastening component 140 in position longitudinally with respect to the curved exit path 106. Examples of fastening component engagement means will be described in relation to the embodiment shown in FIG. 2, in which a first socket 151 and a first recess 131 are positioned on the fixed tail portion 110 at the first connection position 111. The first socket 151 may comprise a radially outward extension of the fixed tail portion 110, as in the example shown. The first socket 151 may comprise an axial bore, whose longitudinal axis can be perpendicular to the body axis 108, and which may receive an insert. The insert may comprise an axially threaded inner surface to engage with a screw of the fastening component 140. The first recess 131 may be disposed on an opposite side of the fixed tail portion 110 to the first socket 151. In the example shown, the first socket 151 and the first recess 131 are positioned on diametrically opposite sides of the first surface portion 121. The first recess 131 may be configured to receive a hinge member 141 of the fastening component 140, as will be described later in relation to FIG. 3. It will be appreciated that fastening means other than a screw in a corresponding hole, or a hinge member in a corresponding recess, could be envisaged to provide a way of fixing the cable 104 at a given position along the curved exit path 106.

The first recess 131 may comprise an opening in the tubular section of the fixed tail portion 110. On a diametrically opposite side of the fixed tail portion 110 to the first recess 131, adjacent to the first socket 151, a first slot 161 may be provided as an opening through the tubular part of the fixed tail portion 110. Therefore, with reference to FIGS. 1 and 2, it will be appreciated that a cable tie or other suitable fastening component may be threaded through the first recess 131, through the first channel or aperture 171 on the underside of the fixed tail portion 110, and through the first slot 161 in order to retain the cable 104 against the cable support surface 120 at the first connection position 111.

In order secure the cable 104 at the second connection position 112 of the curved exit path 106, the third surface portion 123 of the embodiment shown comprises a second socket 152 and a corresponding second recess 132, which may be diametrically opposite to the second socket 152. Furthermore, the third surface portion 123 may comprise a second slot 162. Similarly to that described in relation to the first connection position 111, a suitable fastening component may be threaded through the second recess 132, through the second channel or aperture 172 and through the second slot 162 in order to retain the cable 104 against the cable support surface 120 at the second connection position 112.

In order to secure the cable 104 at the third connection position 113 of the curved exit path 106, the fifth surface portion 125 of the embodiment shown comprises a third socket 153 and a corresponding third recess 133, which may be diametrically opposite to the third socket 153. Furthermore, the fifth surface portion 125 may comprise a third slot 163. Similarly to that described in relation to the first connection position 111, a suitable fastening component may be threaded through the third recess 133, through the third channel or aperture 173 and through the third slot 163 in order to retain the cable 104 against the cable support surface 120 at the third connection position 112.

FIG. 3 illustrates the fixed tail portion 110 with part of the fastening component 140 fixed thereto in the third connection position 113. A hinge or projecting hook member 141, comprised at one end of the fastening component 140, may be configured to engage one of the recesses 131, 132, 133 such that the fastening component 140 can be pivoted with respect to the fixed tail portion 110. In the position shown, the fastening component 140 is in a pivotally open position, in which a cable 104 can be received at the curved exit path 106. At the opposite end of the fastening component 140, a fastening member 142 can be provided, which may comprise a screw. The fastening member 142 may be positioned on the fastening component 140 so as to engage with one of the sockets 151, 152, 153 of the fixed tail portion 110. In the position shown, in which the hinge member 141 is engaged with the third recess 133, the fastening component 140 can be pivoted so as to bring the fastening member 142 into engagement with the third socket 153.

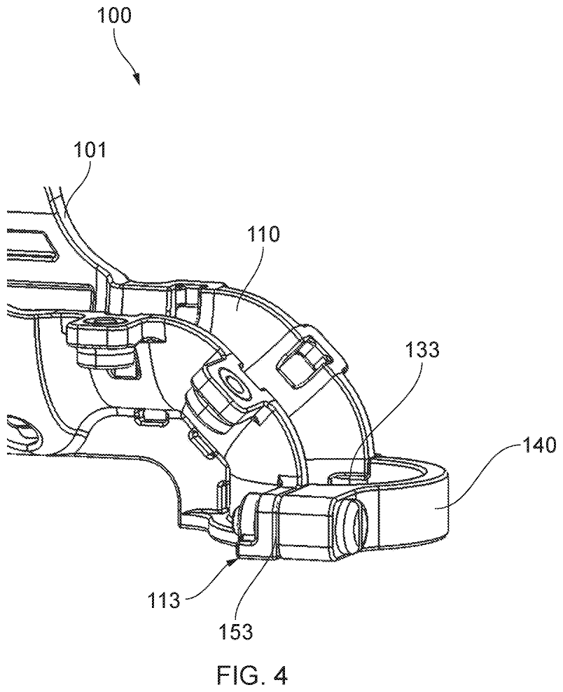

FIG. 4 shows the backshell 100, and more specifically shows the fixed tail portion 110 with the fastening component 140 fixed thereto at the third connection position 113. In this position, the fastening member 142 is shown to be engaged with the third socket 153 such that the fastening component 140 is in a pivotally closed position. It will be appreciated that the inner surface of the fastening component 140 and the curved support surface 120, in particular the fifth surface portion 125, together define a substantially annular aperture in which the cable 104 can be received and retained. The aforementioned aperture in the example shown may have an axis perpendicular to the body axis 108. When a cable 104 is connected to the electrical connector 105 via the backshell body 101 and disposed along the cable support surface 120, to be secured by the fastening component 140, it will be appreciated that the portion of cable 104 emerging from the distal end of the fixed tail portion 110 will be orientated at an angle of approximately 90 degrees to the body axis 108. In other words, when the cable 104 is retained in the third connection position 113 by the fastening component 140 otherwise, the exit angle of the cable will be 90 degrees.

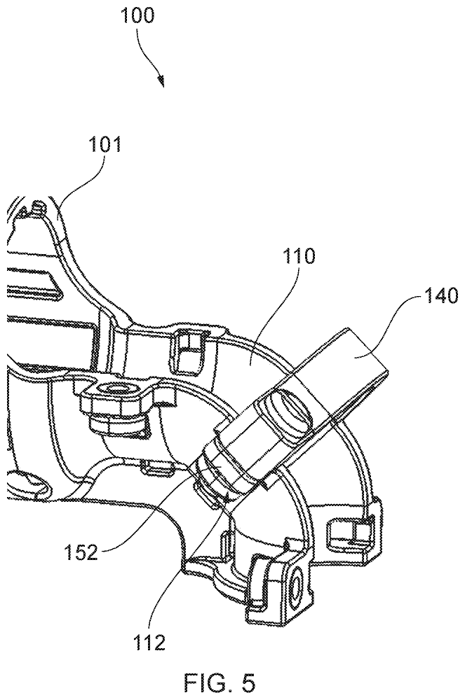

FIG. 5 shows the backshell 100, and more specifically shows the fixed tail portion 110 with the fastening component 140 fixed thereto at the second connection position 112. In this position, the fastening member 142 is shown to be engaged with the second socket 152 such that the fastening component 140 is in a pivotally closed position. It will be appreciated that the inner surface of the fastening component 140 and the curved support surface 120, in particular the third surface portion 123, together define a substantially annular aperture in which the cable 104 can be received and retained. The aforementioned annulus in the example shown may have an axis positioned at 45 degrees to the body axis 108. When a cable 104 is connected to the electrical connector 105 via the backshell body 101 and disposed along the cable support surface 120, to be secured by the fastening component 140, it will be appreciated that the portion of cable 104 emerging from the distal end of the fixed tail portion 110 will be orientated at an angle of approximately 45 degrees to the body axis 108. In other words, when the cable 104 is retained in the second connection position 112 by the fastening component 140 otherwise, the exit angle of the cable will be approximately 45 degrees.

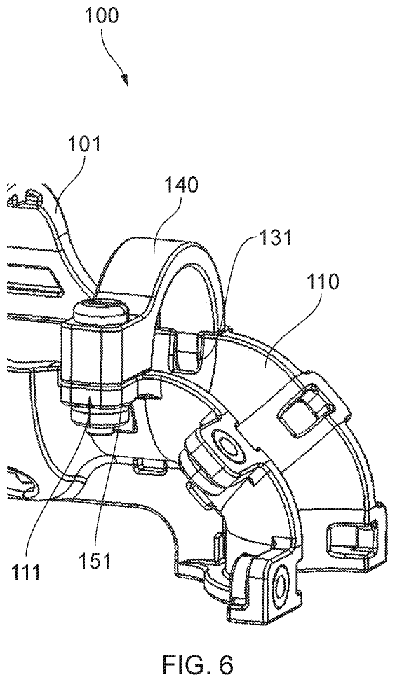

FIG. 6 shows the backshell 100, and more specifically shows the fixed tail portion 110 with the fastening component 140 fixed thereto at the first connection position 111. In this position, the fastening member 142 is shown to be engaged with the first socket 151 such that the fastening component 140 is in a pivotally closed position. It will be appreciated that the inner surface of the fastening component 140 and the curved support surface 120, in particular the first surface portion 121, together define a substantially annular aperture in which the cable 104 can be received and retained. The aforementioned annulus in the example shown may have an axis parallel to the body axis 108. When a cable 104 is connected to the electrical connector 105 via the backshell body 101 and disposed along the cable support surface 120, to be secured by the fastening component 140, it will be appreciated that the portion of cable 104 emerging from the distal end of the fixed tail portion 110 will be orientated approximately parallel to the body axis 108. In other words, when the cable 104 is retained in the first connection position 111, by the fastening component 140 otherwise, the exit angle of the cable will be in the direction of the body axis 108.

In view of the above, the embodiments described herein provide a single backshell to support cables or cable harnesses in a variety of exit angles. In the embodiment described above, the fastening component can be fixed to the fixed tail portion by a screw at one side and a projecting hook or hinge in a recess at the other side. It will be appreciated that the invention could extend to arrangements in which the fastening member is fixed at both sides by a screw, or any similar nut and bolt arrangement. Alternatively, the fastening component may be connected to the fixed tail portion at one or more sides by the projecting hook or hinge and recess arrangement. In other embodiments, a snap fit comprising a flexible member on at least one of the fixed tail portion or the fastening component may be employed to provide a plurality of connection positions.

The arrangement may be further modified such that, at one or more connection positions, the fastening component may be connected to the fixed tail portion so as to provide a changeable aperture in which the cable can be received. In other words, a connection position may be configured to permit a fastening component to be fixed thereto at a selectable one of a plurality of positions, in order to optimise the aperture size depending on the diameter of the cable harness or bundle. This may be realised, for example, by providing a fastening component with at least two holes on a side thereof, through which a bolt can secure the fastening component to the fixed tail portion at one of at least two positions.

In the embodiment described in relation to FIGS. 1 to 6, the backshell can retain the cable in a plurality of bending angles, in the cases illustrated the plurality is three bending angles. In the illustrated examples, the angles are: 0 degrees, 45 degrees and 90 degrees. Other sets of angles can be envisaged. It will be appreciated that the present invention can extend to backshells that support a cable or cable harness in fewer or more bending angles, for example by comprising a different number of connection positions. This could be realised by providing a different number of sets of recesses, sockets, slots and/or apertures. Alternatively, the plurality of connection positions may be provided as a larger number of possible connection positions against which a fastening component could be secured.

A method of assembling an electrical connector 105 to a cable 104 is also disclosed. The method comprises providing an electrical connector 105 and providing a backshell 100, such as the backshell 100 described above with reference to FIGS. 1 to 6, to the electrical connector 105. The method also comprises the step of connecting at least one cable or cable harness 104 to the electrical connector 105. In order to secure the cable or cables to the backshell, one or more of the connection positions 111-113 is selected, and the fastening component 140 is connected to the fixed tail portion 110 at the selected connection position or positions 111-113. While FIGS. 4 to 6 do not illustrate the cable 104, it will be appreciated that the cable 104 could be positioned along the curved exit path 106 before the step of connecting the fastening component 140 to the fixed tail portion 110.

By way of example, FIG. 4 illustrates a backshell 100 wherein the fastening component 140 has been fixed to the fixed tail portion 110 so as to occupy the third connection position 113, while the first 111 and second 112 connection positions have been left unoccupied. In the backshell 100 shown in FIG. 5, the fastening component 140 has been fixed to the fixed tail portion 110 so as to occupy the second connection position 112, while the first 111 and third 113 connection positions have been left unoccupied. In the backshell 100 shown in FIG. 6, the fastening component 140 has been fixed to the fixed tail portion 110 so as to occupy the first connection position 111, while the second 112 and third 113 connection positions have been left unoccupied. Therefore, at least one of the plurality of available connection positions may be unoccupied by any fastening component. As can be understood in light of the above description, the method provides an efficient way to select an exit angle of the cable or cables 104 from the connector 105 using a minimal number of parts and assembly operations.

Various modifications, whether by way of addition, deletion and/or substitution, may be made to all of the above described embodiments to provide further embodiments, any and/or all of which are intended to be encompassed by the appended claims.

1. A backshell configured to be connected to an electrical connector, the backshell comprising:
a backshell body configured to receive a cable connectable with the electrical connector, and
a fixed tail portion extending from the backshell body, the fixed tail portion providing a plurality of connection positions spaced along a curved exit path extending from the backshell body, at which a fastening component can be connected to the fixed tail portion to retain the cable to the fixed tail portion;
the plurality of connection positions comprising fastening component engagement means, configured to retain the fastening component at one of the plurality of connection positions along the curved exit path;
wherein connection of the fastening component to the fixed tail portion at the different respective connection positions guides the cable from the fixed tail portion at different respective exit angles.

2. The backshell according to claim 1, wherein the fixed tail portion is an integral part of the backshell body.

3. The backshell according to claim 1, wherein the curved exit path is defined along a surface of the fixed tail portion.

4. The backshell according to claim 1, wherein the fixed tail portion comprises a cable support surface configured to direct the cable along the curved exit path.

5. The backshell according to claim 4, wherein a proximal end of the cable support surface is parallel to a longitudinal axis of the backshell body and wherein a distal end of the cable support surface is non-parallel to the longitudinal axis of the backshell body.

6. The backshell according to claim 4, wherein the cable support surface has a curved profile.

7. The backshell according to claim 4, wherein the cable support surface comprises a smooth tubular surface.

8. The backshell according to claim 4, wherein the cable support surface is defined by a geometric saddle point.

9. The backshell according to claim 1, further comprising a fastening component configured to be connected to the fixed tail portion at one of the plurality of connection positions, wherein the fixed tail portion and the fastening component are configured to clamp the cable therebetween.

10. The backshell according to claim 1, wherein at least one of the plurality of connection positions comprises an opening configured to engage the fastening component.

11. The backshell according to claim 1, wherein the plurality of connection positions comprises a proximal connection position and a distal connection position.

12. The backshell according to claim 11, wherein the plurality of connection positions further comprises an intermediate connection position located at a position along the curved exit path between the proximal connection position and the distal connection position.

13. The backshell according to claim 4, wherein at least one aperture is provided at an underside of the cable support surface.

14. The backshell according to claim 13, wherein the at least one aperture is located in the region of at least one of the plurality of connection positions, to receive the fastening component so as to retain the cable at the at least one connection position.

15. A method of assembling an electrical connector to a cable, the method comprising:
providing an electrical connector;
providing a backshell according to claim 1 to the electrical connector;
connecting at least one cable to the electrical connector; and
securing the at least one cable to the backshell by selecting at least one of the plurality of connection positions and connecting the fastening component to the fixed tail portion at the selected connection position(s).

16. The method according to claim 15, further comprising leaving at least one of the plurality of connection positions unoccupied by any fastening component.
